(19) United States
(12) Patent Application Publication
(10) Pub. No.: US 2008/0086500 A1
(43) Pub. Date: Apr. 10, 2008

(54) Menu Based Scheduling Process For An Employee Time and Attendance Recording System

(76) Inventors: Luis Garcia, Slinger, WI (US); Bryan D. Dickerson, Hartford, WI (US); Jeffrey A. Kuhlow, Fond du Lac, WI (US); James A. Hennen, Slinger, WI (US); Jeffrey H. Peterson, Jackson, WI (US); Ashley M. Wendt, Fond du Lac, WI (US); Phillip H. Hobbs, Hartford, WI (US)

Correspondence Address: QUARLES & BRADY LLP, 411 E. WISCONSIN AVENUE, SUITE 2040, MILWAUKEE, WI, 53202-4497, US

(21) Appl. No.: 11/539,806

(22) Filed: Oct. 9, 2006

(51) Int. Cl. G06F 17/00

(52) U.S. Cl. 707/103 R

(57) ABSTRACT

A user enters data about a resource into a computer using a method wherein the user selects a data field in which the data is to be entered. In response to that selection, the computer reviews previously stored records related to the resource to find instances of data contained in the data field. Those instances then are displayed to the user, who selects of one of the instances as a value to be entered into the data field. Thus the user is provided with a list of previous values that are contained in the selected data field for the resource, which list facilitates locating and entering information in new records for this resource.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to computer systems for scheduling employees work hours and for recording the actual amount of time that employees work, and more particularly to accessing prior information about each employee being scheduled or for whom time is being recorded.

2. Description of the Related Art

Most large employers utilize a computerized time and attendance system, which has replaced the traditional time clocks that imprinted a card with the date and time that an employee started and ended each work period. These computerized systems utilize devices that read data from employees identification badges upon entering and leaving the workplace. This action identifies each employee to the time and attendance system. That identification data then is transmitted to a central computer for the workplace, which records the employee identification and the current date and time for subsequent use by a payroll program that determines the amount of wages that each employee receives.

Employers also utilize computerized scheduling systems to assign workers to different work shifts during a future wage period. The resultant schedule is printed and provided to each employee prior to commencement of that wage period, thus informing the employee when to report to work and the duration of each work period. In many businesses, an employee's work schedule varies from week to week, and even day to day. In a hospital for example, an employee may be assigned to work eight hours during each of five consecutive days, while other employees may work three consecutive 12 hour days and then not have to report to work for the next four consecutive days. Part-time employees work less than an eight hour day. Some employees may not even be assigned to a specific department, but float being assigned upon reporting for work to wherever additional employees are needed that day. During a given pay period, other employees are scheduled in advance to work in different job categories and are paid at different rates.

Because of the flexible work assignments that many workers experience, a supervisor can choose among a relatively large number of employees when scheduling work shifts for a department. Although many workers may be qualified to fill a given position, it is desirable to select those with recent experience in both that particular job and the specific department or location. For example, many nurses may be generally able to attend to pediatric patients, however because of special patient needs, it is desirable to staff a pediatric nursing station with employees who frequently attend to children.

Although the same employees are repeatedly scheduled to the same job location, there are times when different employees are required to fill vacancies. This requires that the supervisor performing the scheduling review the qualifications of other employees to find ones that are suitable to fill such vacancies. In this situation, the supervisor typically searched the employee records to find suitably qualified workers, which was a time consuming task.

Therefore, rather than providing the supervisor or other computer user with a list of all the possible choices from which to select a given item of data being entered, it is desirable for the sake of efficiency and simplicity to present an abbreviated list that contains only those choices that are most likely to be of interest.

### SUMMARY OF THE INVENTION

A method by which a computer system receives data from a user about a resource involves receiving a selection from a user of a first kind of data to be entered. In response, previous records related to the resource are reviewed to find instances of the first kind of data, which instances are likely presently to be of interest to the user. Those instances then are displayed to the user, who selects of one of the instances as a value for the first kind of data to be entered.

The instances that are displayed to the user represent a group that is most likely to contain the value for the first kind of data that the user desires to enter. In many situations the universe of possible values for the first kind of data is extremely large, which if presented as a list would be time consuming for the user to review in order to find the value desired to be entered. The present process provides a list of the recent values from previous records of the first kind of data which are associated with the related resource, thereby reducing the universe of possible values to those values which are likely to be on interest to the user. The choice of values to display is not based on past activity by the user, but on data stored in the computer system for the resource to which the new data entry relates.

An aspect of the present method allows the user to search for other values for the first kind of data, when the display of the instances does not contain the value that the user desires to enter.

When the user is entering several types of related data, a version of the present method comprises receiving another selection of a second kind of data to be entered. The computer then searches records related to the resource for instances of the second kind of data that are associated with the selected instance of the first kind of data. Thus the possible values for the second kind of data are reduced based on the use of the resource and the selected instance of the first kind of data.

### BRIEF DESCRIPTION OF THE DRAWINGS

FIG. 1 is a schematic diagram of a computer system in a business for scheduling employees work time and recording time and attendance information;

FIG. 2 represents a data file stored in the computer system and containing information about an employee;

FIG. 3 represents the data structure of a file containing work schedules for many employees;

FIG. 4 depicts the data structure of entries in a time and attendance data file for the employees;

FIG. 5 is a display of a work schedule for employees in one department of the business;

FIG. 6 is a flow chart of the menu generation method according to the present invention;

FIG. 7 depicts a display of the screen of a personal computer on which a user enters criteria for searching for a work assignment of an employee;

FIG. 8 illustrates the personal computer screen displaying a pick list of items indicating facilities at which the employee has worked;

FIG. 9 illustrates the personal computer screen displaying a pick list of items indicating departments within one of the facilities at which the employee worked; and

FIG. 10 depicts a personal computer screen displaying a pick list of items indicating a unit within one of the departments at a facility where the employee worked.

### DETAILED DESCRIPTION OF THE INVENTION

Although the present invention is being described in the context of information related to employees, it has application to entering data pertaining to other types of business resources, such as equipment and rooms.

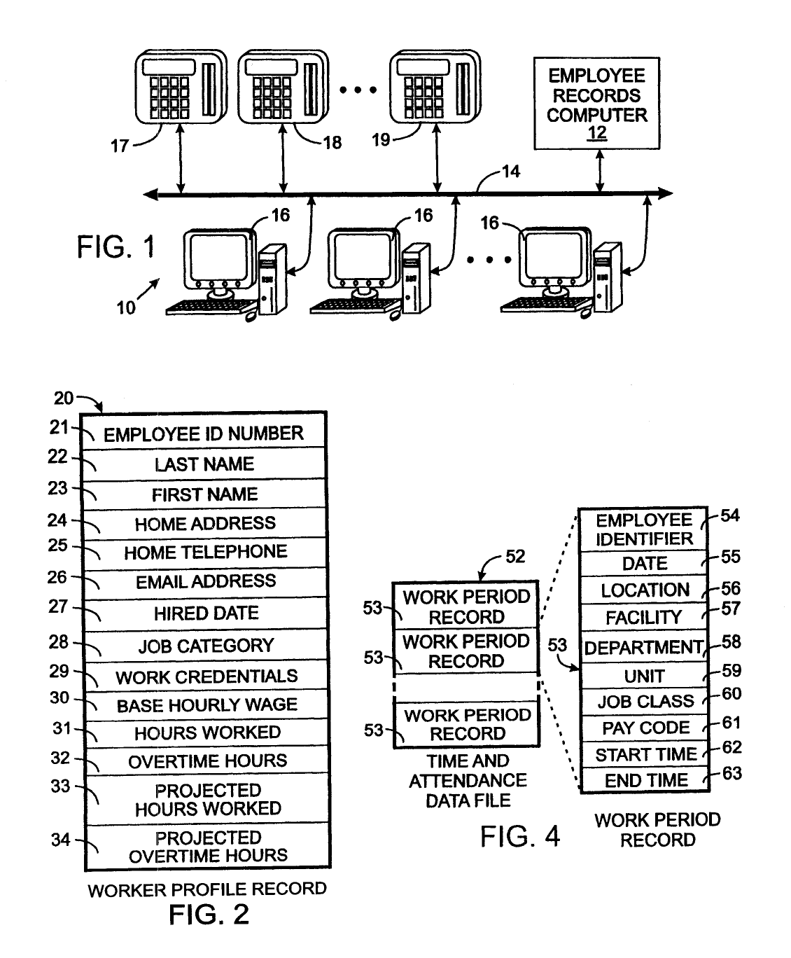

FIG. 1 illustrates a computer system 10 for scheduling work periods for employees and then recording the actual time worked by each employee. This system comprises an employee records computer 12 which executes software programs that perform those functions, and stores employee biographical information, the work schedules and the time and attendance data. The employee records computer is connected to a standard local area network (LAN) 14 of a type commonly found in work places. A plurality of personal computers 16 are connected to the local area network 14 to exchange data and commands with the employee records computer 12. A plurality of commercially available badge readers 17, 18 and 19, through which employees indicate when they start and end periods of work, are located throughout the work place and are connected to the LAN 14. For example, each employee is issued an identification badge that encodes a unique employee number and other information, wherein badge is scanned by badge reader upon the employee arriving and departing the work place. Each badge reader 17-19 has a keypad by which an employee number or other information can be entered. A display device on the card readers 17-19 presents information to the employee.

Although the present invention will be described in the context of scheduling hospital employees, it should be understood that the inventive concepts can be applied to other types of businesses and for scheduling a variety of resources.

FIG. 2 depicts an exemplary profile record 20 stored in the employee records computer 12 and containing biographical information for one employee. Every worker profile record 20 has a plurality of data fields with field 21 storing the person's employee identification number and fields 22 and 23 containing the last and first names of the employee. The person's home address, telephone number and email address appear in fields 24, 25, and 26, respectively. The date that the individual was hired is held in field 27. The employee's regular job category is identified in field 28 with special work credentials, such as training, licenses, certifications, and the like identified in field 29. His/her base hourly wage is given in field 30.

The remainder of the worker profile record 20 contains information about the time worked by the individual. Fields 31 and 32 store the number of regular and overtime hours that the person has actually worked during the current pay period. The projected number of regular hours expected to be worked during the current pay period is stored in field 33, while field 34 specifies the number of overtime hours projected to be worked. Additional fields may be provided to hold year-to-date totals of the regular hours actually worked, overtime hours actually worked, the number of times the employee was tardy and the number of days absent. Preferably fields for these latter items are not provided with the software calculating a particular year-to-date totals whenever that data is needed.

The personal computers 16 enable appropriate personnel to access a standard employee staffing and scheduling program, such as the ActiveStaffer® Series available from api Software, Inc. of Hartford, Wis., U.S.A. This software program provides a listing of all the employees available for assignment to a given department and each employee's work preferences, such as a work shift, vacation schedule, and the like. This enables the employees to be assigned to specific work shifts and to an amount of time during each shift, either automatically by the computer program or manually by a supervisor. Some employees may work eight hour shifts, while others have twelve hour shifts. The schedule for each employee is stored in a work schedule data file within a storage device of the employee records computer 12.

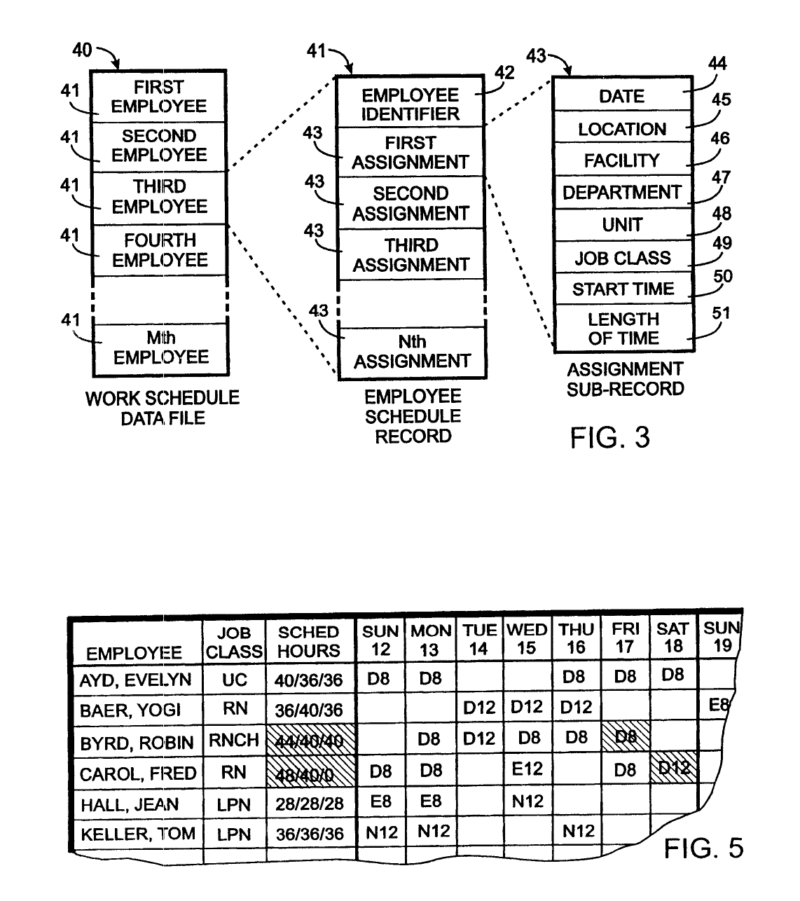

With reference to FIG. 3, the work schedule data file 40 contains a plurality of records 41, each storing the work schedule information for one employee. Employees may be scheduled in advance for one or more weekly periods. For the purpose of describing the present invention, assume that the employees are scheduled in three week periods. Each employee record 41 has a field 42 which contains an identifier of the associated employee. This identifier may be a social security number or a unique employee number assigned by the employer. The remainder of the employee schedule record 41 contains a plurality of work assignment sub-records 43 with the number of such fields varying depending upon how many work periods the employee will work during the three week schedule period. Each work assignment sub-record 43 has a first field 44 which stores the date of the assignment and a second field 45 specifying the location where the employee is to work. The scheduling program may be used by a health care system that operates several hospitals and freestanding clinics and a given employee may work at more than one of those facilities and on different days may be assigned to different areas in the same facility. A third Field 46 contains an indicator of the facility for the subject work assignment and a fourth field 47 has an identification of the department within that facility. A department may comprise several work units, in which case the work unit to which the employee is assigned is specified in a fifth field 48. A sixth field 49 holds information specifying the job class associated with this assignment. A given nurse may work as a regular registered nurse (RN) on some days, and as head nurse or another capacity on other days. The job class also identifies the wage scale that the employee is to receive for this assignment. The seventh and eighth fields 50 and 51 in the sub-record 43 define the start time of the work assignment and its duration. Preferably the duration is specified by the length of the work period (e.g. a number of hours), but alternatively the duration could be indicated by storing the scheduled end time of the work period.

During the scheduling process, data from the work schedule data file 40 is displayed on the screen of the respective personal computer 16 in a spreadsheet format as shown in FIG. 5. In the course of presenting the information, the scheduler software acquires data from the main employee file in order to display that person's name, job class, and other information. Each line of the display corresponds to a different employee and the columns relate to different work days of the pay period. Each cell of the display indicates the shift and the number of hours to be or which have been worked by that employee on that day. For example, D8 designates eight hours on the daytime shift. The letter E denotes the evening shift, while the letter N indicates the night shift. Note that Fred Carol was scheduled to work 48 hours this week (the 48 in the entry 48/40/0), thus being scheduled for eight hours of overtime. This overtime event also is indicated by this employee's highlighted display cell for Saturday the 18^{th}. By placing the cursor on the highlighted display cell and clicking the mouse button, the cell opens up to a window displaying the clock in and out times and the number of hours of regular time and overtime.

The employee records computer 12 in FIG. 1 also executes a time and attendance software program, such as the Payrollmation® Series available from api Software, Inc. of Hartford, Wis., U.S.A. This type of program records the arrival and departure times of the employees within the hospital. As noted previously, each hourly employee scans an encoded employee badge through one of the readers 17-19 upon entering and leaving the work place. This provides an identification of the employee to the employee records computer 12 which logs that identification along with the date and time of day at which the data entry occurred. This implements an electronic time clock which records the arrival and departure of the employees in a time and attendance data file 52 stored within the employee records computer.

With reference to FIG. 4, the time and attendance data file 52 stores a plurality of records 53 each containing information related to a period actually worked by an employee. Specifically each work period record 53 has a first field 54 that contains the identifier for the associated employee and a second field 55 that stores the date on which the work was carried out. Five fields 56, 57, 58, 59, and 60 contain labor distribution information obtained from the corresponding assignment record 43 in the scheduling data file 40, unless manually overwritten by a supervisor. Field 56 identifies the location at which the work was performed, and fields 57-59 specify the facility, department, and unit in which the person worked. Another field 60 defines the job class for this work period, while field 61 stores the pay code that is used to determine the wage for this assignment. In the event that this particular work period relates to an unscheduled assignment, for example an emergency for which the employee was called into work, the labor distribution information in fields 56-60 are created from a manual entries that either the employee makes into a badge reader 17-19, or by a supervisor via a personal computer 16.

When a badge reader 17-19 reads an employee identification badge, the time and attendance software using the employee number read from the identification badge to record the date and time of day in the time and attendance data file 52 for that employee. Based on existing data the software determines whether the employees in entering or leaving the workplace. Subsequently when a payroll is to be generated the time and attendance data are utilized to calculate the number of hours that each employee worked and thus the wages to be paid.

Supervisory personnel use the personal computers 16 to enter scheduling information into the employee records computer 12 and subsequently check and revise the work schedule as may be necessary. For example, if an employee calls in sick, a supervisor has to access the record for the employee's work assignment in order to indicate that the employee is sick or otherwise absent. A typical business, such as a hospital, has scores of departments and potentially several work units within many of those departments. The supervisor in this example has to access the scheduling software program and select menu options drilling down through the computer files to view and change one or more work assignments in which the ill employee is scheduled to work. In some circumstances, the supervisor knows the particular department or departments in which the employee has been scheduled. In other situations, department may not be known or be known only by a colloquial name which is significantly different from the official department name utilized by the scheduling software. In order to facilitate accessing the record containing the work schedule for a given department, the scheduling system utilizes a novel menu system that, instead of presenting an all-inclusive list of every possible selection for a particular data item to be entered, lists only the most likely selections for the relevant scheduled employee.

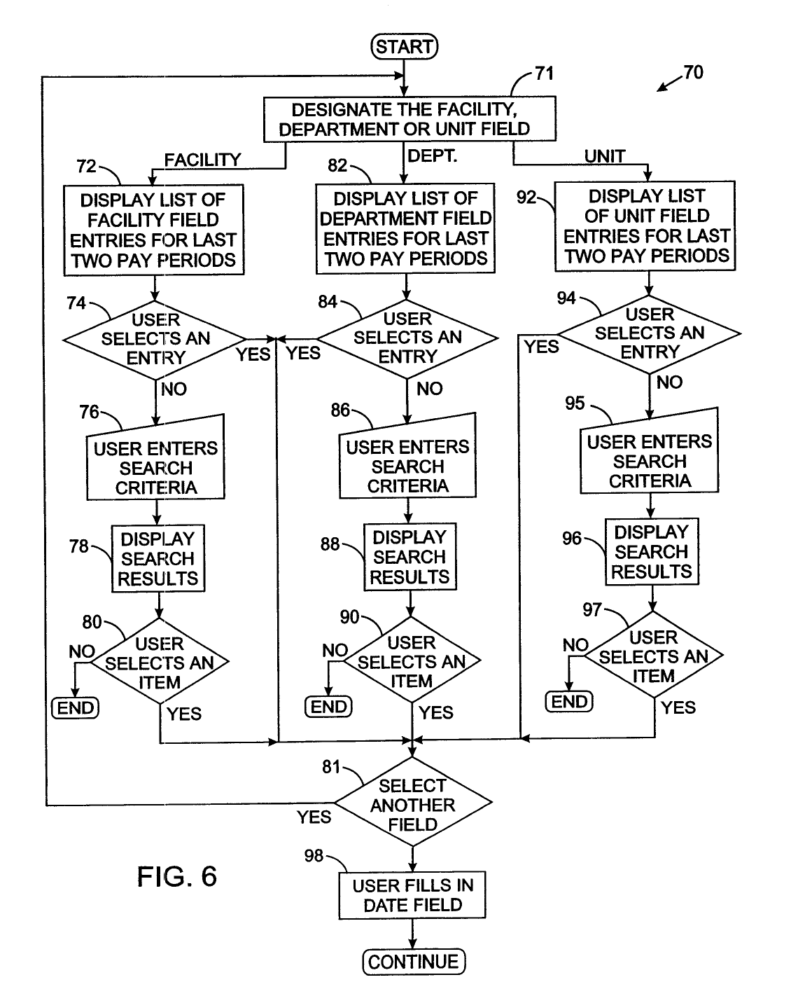

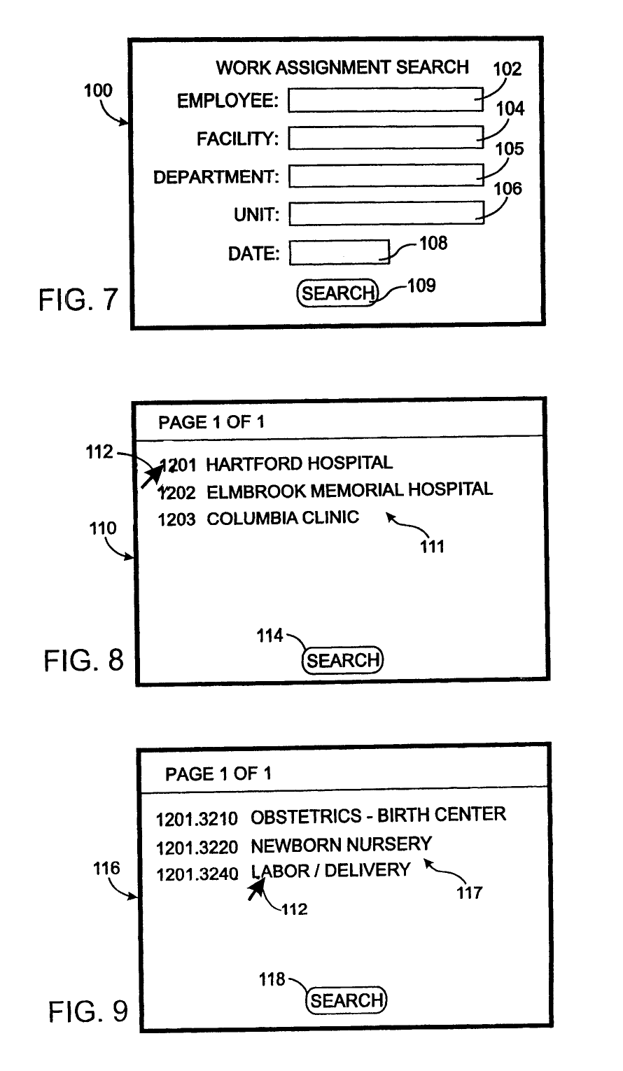

For example, when an employee calls in sick, the supervisor accesses the scheduling software via a personal computer 16 and chooses the option to alter an existing work assignment. That action causes the screen of the personal computer to display a Work Assignment Search form 100 as shown in FIG. 7, on which the supervisor is to enter parameters for locating the desired work assignment. In a first data entry field 102, the supervisor initially designates the employee. This may be accomplished by either entering the person's name or an employee identification number. Then the supervisor has to enter the facility at which the employee is scheduled to work. As noted previously, a healthcare system typically comprises several affiliated hospitals, free standing clinics and other medical facilities and a given employee may be scheduled to work at different ones during a given pay period. The user clicks on the facility data entry field 104, which causes the computer to begin executing the software data entry routine 70 depicted by the flow chart in FIG. 6.

The software data entry routine 70 commences at step 71, which asks the user to designate whether the data desired to be entered is for the field for a medical facility, a department within a facility or a unit of a department. Depending upon the user's designation, the program execution branches to either step 72, 82 or 92.

Assuming that the user designates the medical facility field, the program execution advances to step 72, at which the computer automatically searches the time and attendance data file 52 (FIG. 4) for work period records 53 for this employee to obtain all instances of the facilities at which this employee has worked. Specifically, the routine first obtains the employee identifier entered in field 102 and, using that identifier, searches for work period records which contain that employee identifier in the first field 54. The search reviews work period records for the present pay period and the previous pay period, however additional prior pay periods also could be searched.

For each work period record 53 of the identified employee, the data entry routine 70 extracts the contents of the facility field 57, which contents become an instance of possible data for inserting in the facility field 104 on the Work Assignment Search form 100. Thus, final results of the work period record search contains all instances of the facilities at which this employee worked within recent pay periods. Each of those instances is then displayed on the screen of the personal computer in tabular form as a first menu 110 as shown in FIG. 8, which preferably is a drop-down type menu, but could be a pop-up or other type. Then at step 74, the user selects one of the facilities on the displayed list 111 by placing the cursor 112 over that entry and clicking the computer mouse button. This causes the program execution to advance to step 75.

However, if the list of recent facilities does not contain one of interest to the user, as in the case where the work assignment being sought is at a different facility than where the person worked previously, at step 74 the user clicks the cursor on a search button 114 on first drop-down menu 110. This action causes the data entry routine 70 to branch to step 76, where a search screen is displayed on which the user enters a search criteria for locating names of additional facilities in order to find the one of interest to the user. The results of that latter search are displayed on the personal computer screen at step 78, where the user is afforded the opportunity at step 80 to select one of the displayed items as the facility to enter in the data entry field 104 on the Work Assignment Search form 100 in FIG. 7. If none of the displayed items is acceptable to the user, the user can terminate the menu selection process. Otherwise, by selecting one of the items from the search, the program execution advances to step 81.

At step 81, the data entry routine queries the user whether data for another data field is to be entered. For example, the user now may want to select a department at the medical facility that was just selected. If additional data is to be entered the program execution returns to step 71 at which the use selected the additional type of data.

When the user designates the department field for data entry, the data entry routine 70 waits for the user to click the cursor on the Work Assignment Search form 100 in a data entry field 105 for the department associated with the work assignment being sought. Upon the user doing so, the data entry routine 70 advances to step 82, at which another search of the work period records for the given employee is conducted to obtain each instance of data from the department field 58 of those records that also designate the selected facility. Those instances then are displayed on the personal computer screen as a second drop-down menu 116, as shown in FIG. 9. Thus the user is presented with a list of the departments at the selected facility in which the given employee has worked in the recent pay periods.

Next the data entry routine 70 either advances to step 84 to await the user clicking the cursor 112 either on one of the displayed departments or on a search button 118. Upon selection of a listed department, the routine branches to step 81. Otherwise, if the second drop-down menu 116 does not contain the desired department, clicking on the search button 118 executes a branch to step 86, which displays a search screen enabling the user to enter criteria to use in searching for the desired department. The results of that search are then displayed at step 88 and the user is afforded the opportunity at step 90 to select one of the items found in the search, in which case the execution advances to step 81.

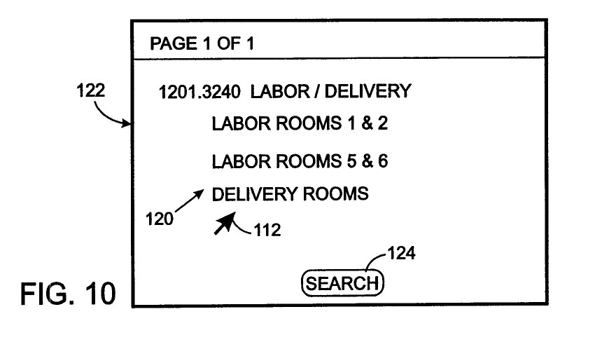

In some applications of the data entry routine 70, selection of a facility and a department are adequate to locate the work record for the particular employee. In other instances, especially when the department is further subdivided into a number of units, the user must complete a unit data entry field 106 on the Work Assignment Search form 100 in FIG. 7. In that latter case, the user responds affirmatively to the query at step 81 thereby causing the execution to return to step 71 where the unit field now is designated by clicking the cursor on the unit data entry field 106. This action initiates yet another search of the work period records for the given employee at step 92. That search obtains each instance of data from the unit field 59 of work period records of the given employee that designate the previously selected facility and department. Those instances are the displayed on the personal computer screen as a third drop-down menu, such as the one depicted in FIG. 10. If at step 94 the user selects one of the units 120 from the third drop-down menu 122, the execution of the data entry routine 70 branched to step 81. However, at this juncture, if the user is not satisfied with any of the displayed units, he may click the cursor 112 on the search button 124 which causes the data entry routine to branch to step 95 for specifying criteria for a special search. In that event, the entry routine searches the names of units within the previously selected facility and department which satisfy the search criteria. The results of the search are then displayed at step 96 and at step 97, the user can select one of the displayed units or terminate the data entry routine.

Selecting one of the displayed units causes the program to advance to step 98. As an example, the user now could enter the date of the work assignment being sought. Entry of the date in data entry field 108 completes filling out the Work Assignment Search form 100 in FIG. 7. By clicking the cursor on the search button 109 the personal computer initiates a query of the employee records computer 12 for the defined work assignments.

Thus, the present menu selection method pares down a relatively large number of possible menu selection items, such as scores of departments within a hospital, to a relatively small number which is likely to contain the one of interest to the user. Specifically, the data entry routine displays the information from the completed work assignments within the previous two pay periods, thus displaying the places within this business in which the employee has worked most recently. It is likely that the future work assignment which is being sought will be for one of those places. Thus, the menu selections presented to the user are those of recent occurrence to the employee whose information is being sought.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. For example, although the present invention has been described in the context of use in altering an employee work assignment, it has application to entering data for a wide variety of computer related tasks. Accordingly, the scope of the invention should be determined from the following claims and not limited by the above disclosure.

1. A method by which a computer system receives data from a user about a resource, that method comprising:
receiving a selection of a kind of data to be entered;
reviewing information related to past uses of the resource to find instances of the kind of data;
displaying the instances to the user; and
receiving a selection of one of the instances.

2. The method as recited in claim 1 further comprising instead of selecting one of the instances:
receiving a request to display a plurality of permitted values for the kind of data;
displaying plurality of permitted values; and
receiving another selection of one of the permitted values.

3. The method as recited in claim 1 further comprising storing the one of the instances.

4. The method as recited in claim 1 further comprising employing the one of the instances to search for information related to the resource.

5. The method as recited in claim 1 wherein the resource is an employee.

6. The method as recited in claim 1 wherein reviewing information related to the resource reviews work assignments of an employee.

7. The method as recited in claim 1 wherein reviewing information related to the resource reviews work records of an employee.

8. A method by which a computer system receives data from a user about a resource, that method comprising:
receiving a first selection of a first field in which data is to be entered;
searching previous records related to the resource for first instances of data for the first field;
displaying the first instances of data;
receiving a second selection of one of the first instances, thereby producing a first selected instance;
receiving a third selection of a second field in which data is to be entered;
searching previous records related to the resource for second instances of data which are associated with the first selected instance;
displaying the second instances of data; and
receiving a fourth selection of one of the second of data thereby producing a second selected instance for entry into the second field.

9. The method as recited in claim 8 further comprising as an alternative to receiving a second selection:
receiving a request to display a plurality of permitted values for the first field; and
displaying the plurality of the permitted values; and
receiving another selection of one of the plurality of permitted values which becomes the first selected instance.

10. The method as recited in claim 8 further comprising as an alternative to receiving a fourth selection:
receiving a request to display a plurality of permitted values for the second field;
displaying all the plurality of permitted values; and
receiving another selection of one of the plurality of permitted values which becomes the second selected instance.

11. The method as recited in claim 8 further comprising storing the first selected instance as an entry for the first field; and storing the second selected instance as an entry for the second field.

12. The method as recited in claim 8 further comprising employing the first selected instance and the second selected instance to search for information related to the resource.

13. The method as recited in claim 8 wherein the resource is an employee, and wherein both steps of searching previous records review work records of the employee.

14. A method by which a computer system receives data from a user about an employee, that method comprising:
receiving a designation of a first field in which data is to be entered;
reviewing work records of the employee for instances of the data related to the first field;
displaying the instances; and
receiving a selection of one of the instances as the data to be entered.

15. The method as recited in claim 14 wherein reviewing work records comprises reviewing work assignments of the employee.

16. The method as recited in claim 14 further comprising using the selection of one of the instances to search for information related to the employee.

17. The method as recited in claim 1 wherein reviewing information comprises searching for past uses of the resource during a plurality of days.

18. The method as recited in claim 8 wherein at least one of searching previous records related to the resource for first instances of data and searching previous records related to the resource for second instances of data comprises searching previous records related to events occurring during a plurality of days.

19. The method as recited in claim 14 wherein reviewing work records of the employee comprises searching for instances of activity of the employee during a plurality of days.

20. The method as recited in claim 14 wherein reviewing work records of the employee comprises searching work assignments of the employee for a plurality of days.

21. A method by which a computer system receives data from a user about a resource, that method comprising:
during a current resource scheduling session, receiving a designation of the resource;
during the current resource scheduling session receiving a designation of a type of data related to the resource;
searching records, produced during at least one previous resource scheduling session, to obtain first instances of the type of data;
displaying the first instances of data; and
receiving a selection of one of the first instances.

22. The method as recited in claim 21 further comprising instead of receiving a selection one of the instances:
receiving a request to display a plurality of permitted values for the type of data;
displaying plurality of permitted values; and
receiving another selection of one of the permitted values.

23. The method as recited in claim 21 further comprising employing the one of the instances to search for information related to the resource.

24. The method as recited in claim 21 further comprising:
receiving a second selection of one of the first instances, thereby producing a first selected instance;
receiving a third selection of a field in which data is to be entered;
searching previous records related to the resource for second instances of data for the field, which second instances of data are associated with the first selected instance;
displaying the second instances of data; and
receiving a fourth selection of one of the second of data thereby producing a second selected instance.

25. The method as recited in claim 21 wherein reviewing previous records related to the resource reviews work records of an employee.
